(19) United States
(12) Patent Application Publication
(10) Pub. No.: US 2005/0196082 A1
(43) Pub. Date: Sep. 8, 2005

(54) Bearing with integral seal

(76) Inventors: Albert Asfour, Brighton, MI (US); Michael Jendro, Johnston, IA (US); Michael Kim, Marlton, NJ (US); Richard Saile, Phoenixville, PA (US)

Correspondence Address: John M. Harrington;Kilpatrick Stockton LLP, 1001 West Fourth Street, Winston-Salem, NC, 27101, US

(21) Appl. No.: 11/047,444

(22) Filed: Jan. 31, 2005

Related U.S. Application Data
(60) Provisional application No. 60/539,948, filed on Jan. 29, 2004.

(51) Int. Cl. F16C 33/74; F16C 33/76

(52) U.S. Cl. 384/147

(57) ABSTRACT

A seal assembly including an annular filament wound bearing having a first end and a second end and a large longitudinal central aperture, with the first and second ends having a counterbore formed in an interior wall surface of the bearing, the counterbores begin defined by an axially inner surface and a radially outer surface, and a seal disposed within each of the counterbores contacting at least one of said axially inner surface or said radially outer surface of the counterbore, the seal comprising a body portion and an radially inward extending sealing lip.

### CROSS REFERENCE TO RELATED APPLICATIONS

The present application claims priority under 35 U.S.C. § 119(e) from U.S. Provisional Patent Application Ser. No. 60/539,948 filed Jan. 29, 2004, entitled “Integrally Sealed Filament Wound Bearings”, the disclosure of which is incorporated herein by reference.

### FIELD OF THE INVENTION

The present invention relates to bearing and seals. More particularly, the present invention relates to bearings with integral seals associated therewith.

### BACKGROUND OF THE INVENTION

Bearings are often employed with seals when used in an operating environment where contaminate is likely to enter the interior of the bearing and damaging the bearing surface or shaft. In agricultural and construction environments equipment is often operated in an area that is saturated with dust and dirt. The structural members, hydraulic cylinders and linkages employ bearings as part of the pivot pin. If contaminates enter the bearing, they can wear away the sliding surface and lead to premature failure of the bearing.

The traditional solution to this problem has been to use a greased seal to keep contaminates from entering the bearing. Problems with this solution include the propensity of the grease to attract and retain dirt and the continual need to re-grease the seals. Often an operator will be required to re-grease the seals daily. If the seals are not re-greased, contaminants can enter the bearing and prematurely wear the bearing lining.

Another approach to sealing the interior of a bearing is to employ a rubber or other flexible seal along with a traditional bearing design in an attempt to provide a sealing function to protect the interior of the bearing. However, there are several disadvantages with this design. Primarily, the bearing and seal may become separated and/or not work in unison through movement of the shaft relative to the bearing and seal. This greatly reduces the effectiveness of the seal and presents contaminate to the bearing. Further, assembling a bearing with separate seals can become complicated and time consuming when performed during installation of the bearing. This leads to increased downtime for the equipment and more opportunity for improper installation.

It would, therefore, be desirable to provide a bearing with an integrated seal firmly affixed and incorporated into the bearing structure. Further, it would be advantageous to provide a bearing and seal combination which did not require the use of grease. It would also be desirable to provide such a bearing with integral seal (or seals) as a single unit which can be delivered to a customer and installed as one unit.

It is to these perceived needs that the present invention is directed.

### SUMMARY OF THE INVENTION

In a first aspect of the present invention, a seal assembly is provided comprising an annular bearing comprising a first end and a second end and a large longitudinal central aperture, wherein the first end comprises a counterbore formed in a wall surface of the bearing, the counterbore having an axially inner surface and a radially outer surface, and wherein a seal is disposed within the counterbore and contacts at least one of the axially inner surface or the radially outer surface of the counterbore.

In a preferred embodiment of the present invention, the bearing is a filament-wound bearing, formed of one-piece construction, with an additional counterbore formed in the second end of the bearing, and further comprising a second seal in the additional counterbore.

In an alternate embodiment of the present invention, the bearing is formed of two-piece construction. The two-piece construction comprises an outer cylinder of a predetermined inner diameter and an inner cylinder of a predetermined outer diameter which is equal to or less than the inner diameter of the outer cylinder. In a preferred embodiment of the present invention, the outer cylinder comprises steel and the cylinder of smaller diameter comprises a bearing material.

In a further aspect of the present invention, the seal comprises a body portion and an radially inward extending potion forming a sealing lip and said axially inward extending portion is flexible relative to said body portion. To enhance this flexibility the seal further comprises a void positioned between said body portion and said axially inward extending portion. In a preferred embodiment of the present invention, the seal further comprises a rigid insert formed into the body portion of said seal. The rigid insert comprises an annular insert with an “L” shaped cross section, wherein one leg of the insert extends in an axial direction along the axial surface of the seal, and the other leg of the insert extends into the body portion of the seal.

In further preferred embodiments of the present invention, the bearing comprises filament wound glass-backed high strength PTFE fiber, the seal comprises thermoplastic polyurethane, and the seal is affixed in said counterbore with an adhesive.

In a second aspect of the present invention, a seal assembly is provided comprising an annular bearing comprising a filament wound bearing having a first end and a second end and a large longitudinal central aperture, wherein the first and second ends comprise a counterbore formed in an interior wall surface of the bearing, the counterbores begin defined by an axially inner surface and a radially outer surface, and a seal is disposed within each of the counterbores and contacts at least one of said axially inner surface or said radially outer surface of the counterbore, the seal comprising a body portion and a radially inward extending sealing lip.

One advantage of the seal assembly of the present invention is a unitized bearing and seal which can be distributed to an end user as one unit, thereby eliminating the need for assembly of the bearing/seal combination by the end user. This ensures proper alignment of the seals and reduces installation time of the bearing integrated seals into the end use apparatus.

Features of a bearing with integral seal of the present invention may be accomplished singularly, or in combination, in one or more of the embodiments of the present invention. As will be appreciated by those of ordinary skill in the art, the present invention has wide utility in a number of applications as illustrated by the variety of features and advantages discussed below.

Thus, there has been outlined, rather broadly, the more important features of the invention in order that the detailed description that follows may be better understood and in order that the present contribution to the art may be better appreciated. There are, obviously, additional features of the invention that will be described hereinafter and which will form the subject matter of the claims appended hereto. In this respect, before explaining several embodiments of the invention in detail, it is to be understood that the invention is not limited in its application to the details and construction and to the arrangement of the components set forth in the following description or illustrated in the drawings. The invention is capable of other embodiments and of being practiced and carried out in various ways.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

So that the manner in which the above-recited features, advantages and objects of the invention, as well as others which will become more apparent, are obtained and can be understood in detail, a more particular description of the invention briefly summarized above may be had by reference to the embodiment thereof which is illustrated in the appended drawings, which drawings form a part of the specification and wherein like characters of reference designate like parts throughout the several views. It is to be noted, however, that the appended drawings illustrate only preferred and alternative embodiments of the invention and are, therefore, not to be considered limiting of its scope, as the invention may admit to additional equally effective embodiments.

### BRIEF DESCRIPTION OF THE DRAWINGS

FIG. 1 is a cross sectional view of a seal assembly in an embodiment of the present invention.

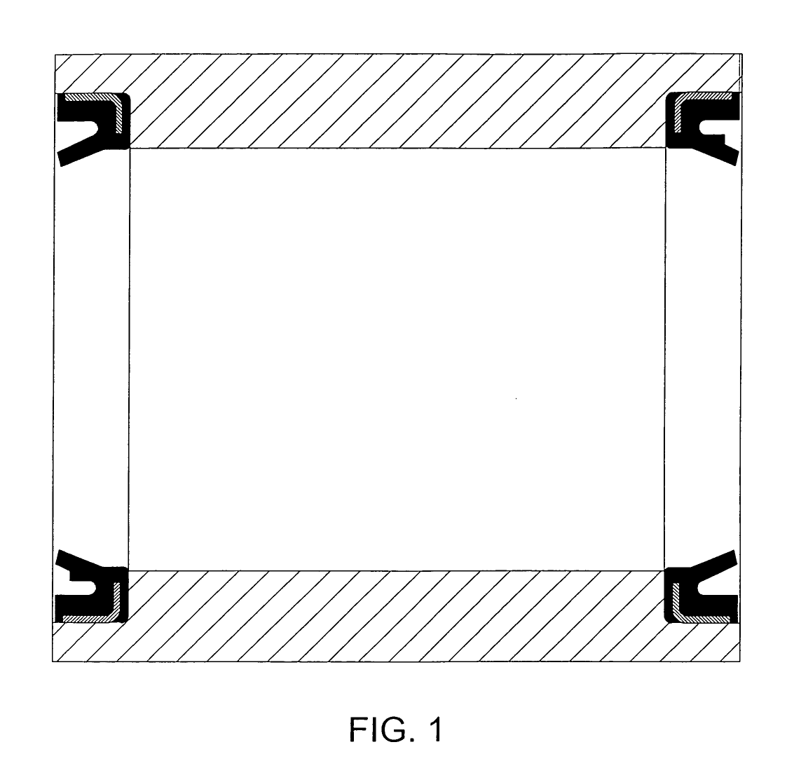

FIG. 2 is a cross sectional view of a bearing for use in a seal assembly in an embodiment of the present invention.

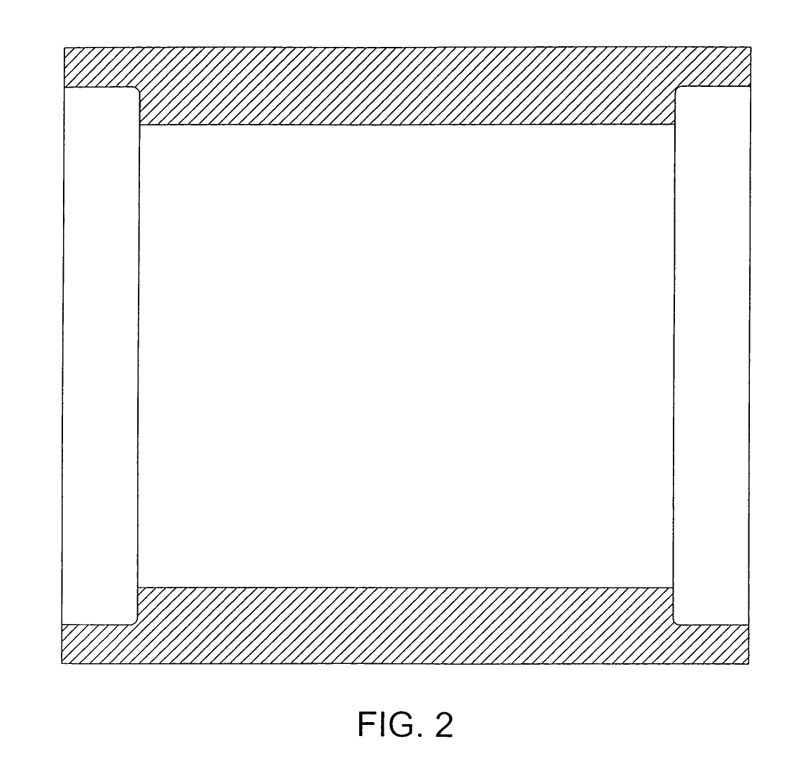

FIG. 3 is a cross sectional view of a seal for a seal assembly in an embodiment of the present invention.

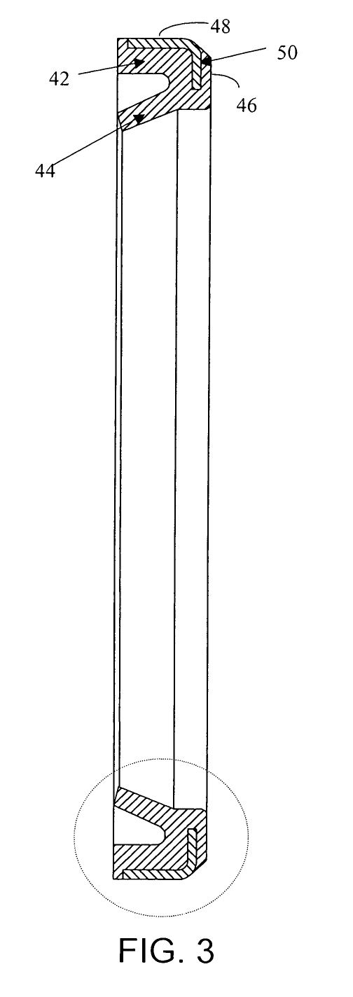

FIG. 4 is a partial cross sectional detailed view of the circled portion of the seal of FIG. 3 in an embodiment of the present invention.

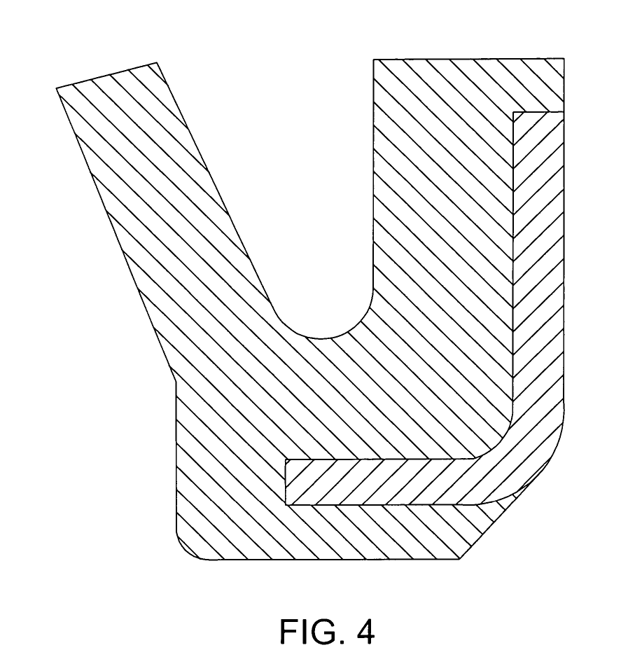

FIG. 5 is a cross sectional view of a seal assembly in an embodiment of the present invention.

### DETAILED DESCRIPTION

Referring now to the figures, in embodiments of the present invention, a seal assembly 10 is provided comprising an annular bearing 20 having a first end 22, a second end 24 and a large central aperture. The ends 22, 24 comprise a counterbore 30 formed in a wall surface of the bearing. The counterbore 30 has an axially inner surface 32 and a radially outer surface 34. A seal 40 is disposed within the counterbore 30 and contacts at least one of said axially inner surface 32 or said radially outer surface 34 (or both) of the counterbore.

The bearings 20 employed in the present invention are preferably cylindrical in shape with a center bore for receiving a shaft. The interior wall of the bearing 26 comprises a lubricious material to facilitate a low-friction contact surface between the shaft and surrounding housing. The bearings used in the present invention may be constructed of any suitable bearing material known in the art. The actual bearing material used will generally be determined by the environmental conditions of its end use.

In a most preferred embodiment of the present invention, the bearing comprises a filament-wound bearing. Filament wound bearings are preferred for use in the present invention over other bearing types partially due to their resilience and self-lubricating nature. Metallic bearings can corrode, wear quickly causing “end-play” in the linkages, and create resonate noise during operation. Metallic bearings often require a separate lubricant, such as grease, to reduce these problems. In contrast, a filament-wound bearing is self-lubricating and more tolerable to edge loading due to misalignment and pin deflection under load.

One common method for manufacturing filament wound bearings comprises choosing a filament and winding it in a crisscrossed multi-layered configuration a mandrel to form a porous bearing structure. Pore size, spacing and wall thickness of the bearing are controlled during the winding process. Preferred filaments for use in the filament-wound bearing include PTFE, polyester, polyamide, or glass fibers. The bearing structure is then diffusion bonded in a furnace and subsequently densified between mandrels. The slightly porous bearing is then impregnated with an epoxy resin or other suitable antigalling compound.

Another process for manufacturing filament wound bearings comprises taking a continuous fiber strand and running it through a resin bath, then winding the resin coated fiber strand about a mandrel. The resin coated fiber strands are wound to the desired shape and thickness. The wound bearing is then cured and removed from the mandrel, then precisely finished to the desired dimensions.

Once the bearing material is chosen and the bearing 20 is formed into a cylinder, the cylindrical bearing is machined to provide a counterbore 30 in at least one end thereof. The counterbore 30 is preferably formed by machining away a potion of the inside wall 26 of the bearing near one end 22, 24. This results in an area of enlarged inside diameter at the end of the bearing with a thinner wall thickness 36 than the remainder of the bearing. In a preferred embodiment of the present invention, a counterbore is formed at both ends of the bearing.

In another embodiment of the present invention, the counterbore is formed during the construction of the bearing, for example, by forming the bearing over a mold which includes areas of larger diameter at one or both ends to provide the counterbore.

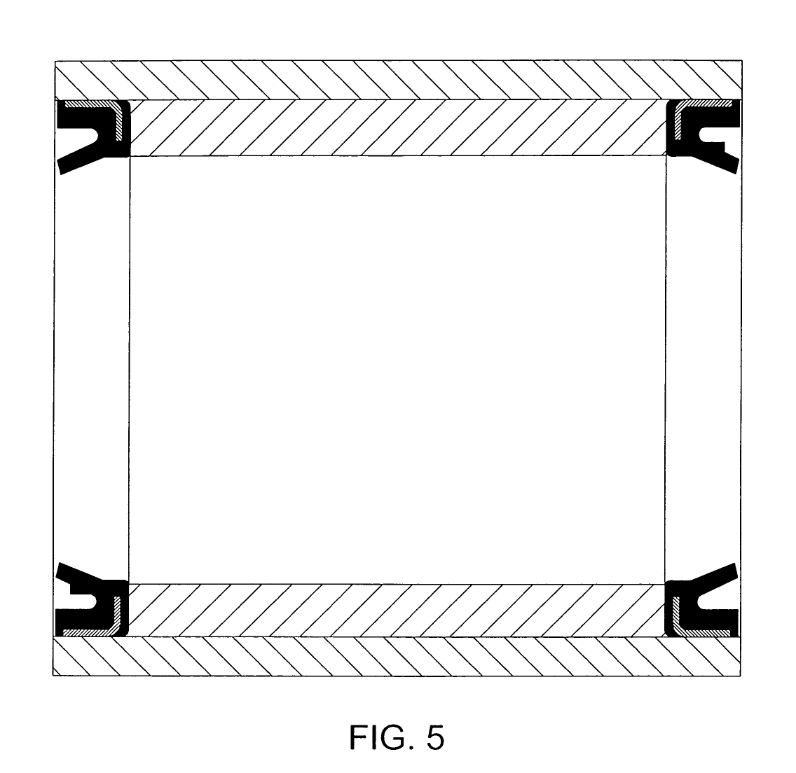

In a still further embodiment of the present invention, shown in FIG. 5, the counterbore is formed of two-piece construction by fitting an outer cylinder 60 with a inner cylinder 20 comprising a bearing material. The inner cylinder 20 is provided with an outer diameter which is equal to or less than the interior diameter of the outer cylinder such that the two cylinders provide a tight fit there between. The inner cylinder 20 is further dimensioned to be shorter in length than the outer cylinder 60 such that when placed within the outer cylinder 60, a counterbore area 30 is formed between the end of the inner cylinder 22 and the end of the outer cylinder 62.

In a preferred embodiment of the present invention, regardless of the method of construction, the counterbore 30 is defined by an axially outer wall 34, parallel to the axis of rotation, and a radially extending wall 32 perpendicular to the axis of rotation thereby forming a “squared off” counterbore for receiving a seal element 40. It should be noted that in other embodiments of the present invention, the geometry of the counterbore may be rounded or angled to enhance the characteristics of the seal assembly.

The counterbore 30 is fitted with a seal 40 comprising a body portion 42 and a radially extending portion 44 designed to contact and form a seal between the bearing 20 and the rotating shaft (not shown). The seal 40 preferably comprises an annular ring having a cross section comprising a substantially rectangular body portion 42 having an axially extending face 48 and a radially extending face 46. The axially extending face 48 aligns with and contacts the axially extending wall 34 of the counterbore 30, and the radially extending face 46 contacts the radially extending wall 32 of the counterbore. In this manner, the seal is fitted into the counterbore and secured in place through contact with the sides and rear of the counterbore.

The radially extending portion 44 of the seal 40 depends radially inward from the body portion 42 and forms a sealing lip which is flexibly engaged to the body portion. In a preferred embodiment of the present invention, the seal 40 is formed of one-piece construction with a void 58 between the body portion 42 and the sealing lip 44 to enhance the flexibility of the lip 44. The lip 44 is permitted to flex into this void 58 provided between the body 42 and the lip 44 during periods of radial displacement of the shaft.

Through this design the sealing function is preserved even during periods of radial displacement of the shaft relative to the bearing and seal. The primary purpose of the seal is to exclude contaminates and other particulate matter from the interior of the bearing which might interfere or increase wear of the interior bearing surface or the shaft.

In a most preferred embodiment of the present invention, the outer diameter of the main body of the seal is equal to or slightly less than the inner diameter of the counterbore such that the seal is retained within the counterbore through frictional contact between the outer diameter of the seal and the inner diameter of the counterbore.

In alternate embodiments of the present invention, the axially outer end of the seal may be flush with the end of the bearing, protruding slightly from the end of the bearing or recessed within the counterbore.

In another embodiment of the present invention, the seals are affixed to the bearing with an adhesive to provide additional support. The preferred adhesive for use with the present invention is a pressure sensitive spray adhesive such as Super 77™ adhesive manufactured by 3M. However any adhesive compatible with the materials of construction of the bearing and the seal may be used with the embodiments of the present invention.

In a further embodiment of the present invention, after the seal is positioned within the counterbore, the end of the bearing is compressed slightly to decrease the diameter of the counterbore at the end of the bearing and retaining the seal therein. In this manner, the end of the bearing is crimped to physically restrain axial movement of the seal away from or out of the counterbore.

In one embodiment of the present invention, the seal comprises an elastomeric material, and preferably, a hard plastic material such as polyurethane which exhibits high wear resistance during service. Other suitable materials for use in the present invention include fluorinated polymers such as PTFE, resins, or other lubricious plastic materials.

In another embodiment of the present invention the seal 40 is further provided with a rigid insert 50 to provide additional strength and rigidity to the body portion of the seal. In a most preferred embodiment of the present invention, the insert 50 is a steel ring having approximately an “L” shaped cross section. One leg 52 of the “L” extends axially along a radially outer portion of the seal body, and the second leg 54 of the “L” extends radially inward into the body portion of the seal. The radially inward extending leg 54 of the insert 50 is preferably positioned rearward in the seal body from the area at which the radially extending portion 44 joins the seal body 42, rearward of the void 58.

Although steel is the preferred rigid material for use as the insert, other high-strength materials are also suitable. For example, in a highly corrosive environment, a polymeric or other non-reactive material of greater rigidity that the seal may be used in place of steel. Additionally, the geometry of the rigid insert may include additional radially extending portions or other members designed to provide a desired degree of rigidity to the seal body.

Although the present invention has been described with reference to particular embodiments, it should be recognized that these embodiments are merely illustrative of the principles of the present invention. Those of ordinary skill in the art will appreciate that the apparatus and methods of the present invention may be constructed and implemented in other ways and embodiments. Accordingly, the description herein should not be read as limiting the present invention, as other embodiments also fall within the scope of the present invention.

1. A seal assembly comprising an annular bearing comprising a first end and a second end and a large longitudinal central aperture, wherein said first end comprises a counterbore formed in a wall surface of the bearing, said counterbore having an axially inner surface and a radially outer surface; and,
wherein a seal is disposed within said counterbore and contacts at least one of said axially inner surface or said radially outer surface of the counterbore.

2. The seal assembly of claim 1, wherein said bearing is a filament-wound bearing.

3. The seal assembly of claim 1, wherein an additional counterbore is formed in said second end of the bearing, and further comprises a second seal.

4. The seal assembly of claim 1, wherein said bearing is formed of one-piece construction.

5. The seal assembly of claim 1, wherein said bearing is formed of two-piece construction.

6. The seal assembly of claim 5, wherein said two-piece construction comprises an outer cylinder of a predetermined inner diameter and an inner cylinder of a predetermined outer diameter which is equal to or less than the inner diameter of the outer cylinder.

7. The seal assembly of claim 6, wherein said outer cylinder comprises steel.

8. The seal assembly of claim 6, wherein said cylinder of smaller diameter comprises a bearing material.

9. The seal assembly of claim 1, wherein said seal comprises a body portion and an radially inward extending potion forming a sealing lip.

10. The seal assembly of claim 1, wherein said axially inward extending portion is flexible relative to said body portion.

11. The seal assembly of claim 10, wherein said seal further comprises a void positioned between said body portion and said axially inward extending portion.

12. The seal assembly of claim 10, wherein said seal further comprises a rigid insert formed into the body portion of said seal.

13. The seal assembly of claim 12, wherein said rigid insert comprises an annular insert with an “L” shaped cross section, wherein one leg of the insert extends in an axial direction along the axial surface of the seal, and the other leg of the insert extends into the body portion of the seal.

14. The seal assembly of claim 1, wherein said bearing comprises filament wound glass-backed high strength PTFE fiber.

15. The seal assembly of claim 1, wherein said seal comprises thermoplastic polyurethane.

16. The seal assembly of claim 1, wherein said seal is affixed in said counterbore with an adhesive.

17. A seal assembly comprising an annular bearing comprising a filament wound bearing having a first end and a second end and a large longitudinal central aperture, wherein said first and second ends comprise a counterbore formed in an interior wall surface of the bearing, said counterbores begin defined by an axially inner surface and a radially outer surface;
wherein a seal is disposed within each of said counterbores and contacts at least one of said axially inner surface or said radially outer surface of the counterbore, said seal comprising a body portion and an radially inward extending sealing lip.
